(19) United States
(12) Patent Application Publication
(10) Pub. No.: US 2005/0263652 A1
(43) Pub. Date: Dec. 1, 2005

(54) Writing aid

(76) Inventor: David C. Stair, Hamden, CT (US)

Correspondence Address: MCCORMICK, PAULDING & HUBER LLP, CITY PLACE II, 185 ASYLUM STREET, HARTFORD, CT, 06103, US

(21) Appl. No.: 10/853,329

(22) Filed: May 25, 2004

(51) Int. Cl. B43L 15/00

(52) U.S. Cl. 248/118.5; 248/118.1; 248/118

(57) ABSTRACT

According to the present invention, a writing aid includes a platform, a top layer and two or more bearings. The platform has a first and second surface. The top layer is affixed to the second surface of the platform wherein the top layer is made of a material that provides cushioning between the user's hand and the platform. The bearings are attached to the first surface of the platform and are operable to reduce the friction between the platform and a writing surface. At least one of the bearings is a linear bearing. During use, the user places his or her writing hand on the top surface. As the user writes, the writing aid continually slides and/or rolls across the writing surface, providing support to the user's writing hand. In some embodiments, the writing aid may be adapted to be used in conjunction with a guide ruler for additional control.

### BACKGROUND OF THE INVENTION

1. Technical Field

The present invention relates to writing aids, in general, and to a rollable platform for supporting the hand while writing, in particular.

2. Background Information

Although handwriting is often overlooked in the digital age, penmanship is an art used by many on a daily basis. Illegible handwriting can lead to undesirable delays in transmitting information. Among physicians and other healthcare personnel, poor handwriting can have serious consequences. In the Institute of Medicine's annual report, “To Err is Human” (2000) medical errors were shown to be a substantial cause of morbidity and mortality. Among the many sources of medical errors, illegible handwriting was cited as a frequent contributor. There is clearly a need for better handwriting legibility. But precisely how to achieve that consistently remains a widespread problem.

It is typically easier to write legibly when the hand is leading the pen across the page. For example, when writing from left-to-right, top-to-bottom, right-handed people are at a distinct advantage over left-handed people. While writing, the right-handed writer is able to slide his or her hand/wrist smoothly and evenly across the page, thus maintaining a desirable distance between the portion of the hand in contact with the writing surface and the point at which the writing instrument contacts the paper.

By contrast, left-handed people who write from left-to-right, top-to-bottom are potentially at a significant disadvantage. Not all left handers have terrible handwriting, but many do! The left-handed writer has difficulty sliding his or her hand smoothly and evenly across the page. The writing hand's movement requires a pushing, a periodic, discontinuous inching forward. Accordingly, the left-handed writer will often resort to writing an entire word with his or her hand in a single position, rather than sliding the hand/wrist along the writing surface. Left handers cannot perform the pushing movement smoothly, in contrast, right-handers can pull the hand smoothly across the page while scripting. As the left-handed writer progresses through a word, he or she must stretch his or her fingers in order to advance the writing instrument across the writing surface and maintain the proper spacing between the letters. Therefore, the distance between the hand the point at which the writing instrumentis in contact with the paper, necessarily changes. As the fingers stretch out to complete a word, the letters often shrink in size, become narrower, and end up being spaced much closer together. The consequence is drastically reduced for clarity and legibility. Right-handed writers can usually keep this distance fairly constant. The problem is especially pronounced in children, who typically have smaller fingers that are unable to reach. The result is often handwriting that is difficult to read, or completely illegible.

The above-referenced problem is not limited to left-handed people. In Arabic and Hebrew, for example, words are typically written from right-to-left across the page. Therefore, the same problem may extend to right handed persons writing in their native Middle Eastern languages. In addition, artists that move their hands across the page without a set pattern experience similar difficulties when drawing in a direction where the writing instrument leads the hand.

Therefore, it is desirable to provide a writing aid that overcomes the known shortcomings in the prior art.

### DISCLOSURE OF THE INVENTION

According to the present invention, a writing aid includes a platform, a top layer and two or more bearing systems. The platform is sized to accommodate a hand or wrist of a user and has a first surface and second surface. The housing or framework of two or more bearing systems are attached to the first surface of the platform and are operable to reduce the friction between the platform at the writing surface. At least one of the bearings is a linear bearing. The top layer is affixed to at least a portion of the second surface of the platform. The top layer is made of a material that provides cushioning between the user's hand and the platform.

According to one aspect of the present invention, the writing aid includes a loop. The loop is attached to one or both of the top layer and the platform and is operable to be selectively wrapped around at least part of the user's hand.

According to another aspect of the present invention, the writing aid includes a guard that is attached to one or both of the top layer and the platform. The guard extends substantially over at least one side of the writing aid to a position adjacent at least one of the bearings.

One advantage of the present invention is the fact that a user can continually maintain a desired distance between the position at which his or her hand is supported on the writing aid and the position at which the writing instrumentis in contact with the writing surface.

Another advantage of the present invention is the fact that the linear bearings guide the writing aid to travel linearly, thereby making it easier for the user to write along a straight line.

A further advantage of the present invention is the fact that the top layer of the writing aid provides cushioning to prevent the user's hand from being uncomfortable or fatiguing.

It will be obvious to those skilled in the art that various changes may be made without departing from the scope of the present invention and that the invention is not to be considered limited to what is described and exemplified in the specification.

### BRIEF DESCRIPTION OF THE DRAWINGS

FIG. 1 is a perspective view of one embodiment of the present invention;

FIG. 1A a bottom view of one embodiment of the present invention having linear bearings aligned in a cage assembly, the cage assembly being to the platform in a manner such that the cage assembly is able to glide freely back and forth relative to the platform during use;

FIG. 2 is a bottom view of one embodiment of the present invention having both linear bearings and ball bearings;

FIG. 3 is a perspective view of one embodiment of the present invention wherein a top layer is ergonomically contoured;

FIG. 4 is a bottom view of one embodiment of the present invention that is adapted for use with a guide ruler;

FIG. 5 is a side view of the embodiment of the present invention shown in FIG. 4; and

FIG. 6 is a perspective view of the embodiment of the present invention shown in FIG. 4 slidably attached to the guide ruler.

### DETAILED DESCRIPTION OF THE INVENTION

Referring to FIG. 1, the writing aid 10 of the present invention includes a platform 12, a top layer 14, and two or more bearings 16. In some embodiments, at least one of the bearings 16 is a linear bearing 17.

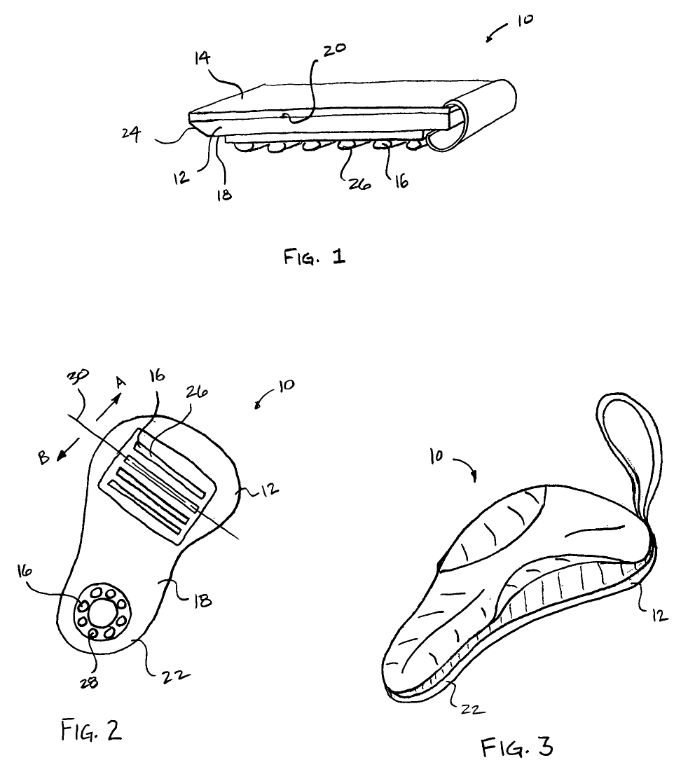

Referring to FIGS. 1 and 2, the writing aid 10 includes a platform 12 having a first surface 18 and a second surface 20. In some embodiments, the platform 12 is generally lightweight, flat and rigid. The platform 12 may be made of any suitable material including, but not limited to, wood, metal and polymeric materials. The platform 12 is thin and is preferably less than ⅛″ thick (1.5 mm in one embodiment); however, platforms thicker than ⅛″ are acceptable in some embodiments.

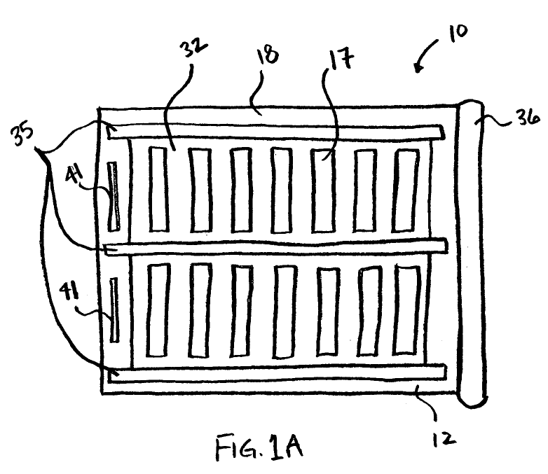

The platform 12 is sized to accommodate the writing hand of the user during use. Therefore, the size of the platform 12 may vary depending on the age of the intended user and/or the size of the actual end user's hand. The platform 12 may also be of any suitable shape. In some embodiments, the platform 12 is generally rectangular (see FIG. 1). However, in other embodiments, the platform 12 is generally shaped to match the outline of the portion of the user's hand that is typically used for support when writing (as shown in FIGS. 2 and 3). In these embodiments, the platform typically includes an elongated rear portion 22 to provide additional support for the hand and/or wrist of the user, as shown in FIG. 2.

Referring back to FIG. 1, one or more of the sides 24 of the platform 12 may be chamfered or rounded. Removing the edge, or corner, along one or more sides 24 of the platform 12 enables the writing aid 10 to smoothly transition from a first writing surface to a second writing surface. For example, when a user is writing on a piece of paper resting on a desk, the user may desire to have the writing aid 10 travel from the desk surface to the surface of the paper. In the above-described instance, the chamfered or rounded side 24 is operable to decrease the likelihood of the writing aid 10 “catching” or “snagging” the edge of the paper when transferring from the surface of the desk.

Referring to FIGS. 1 and 2, the writing aid 10 includes at least two bearings systems 16. The bearings 16 are affixed to the first surface 18 of the platform 12 and are operable to reduce the friction between the writing surface and the platform 12. Suitable bearing 16 shapes include, but are not limited to, spherical bearings 28 (i.e., ball bearings) and cylindrical bearings 17 (i.e., linear bearings). In addition, bearings 16 having barrel, conical, and frustro-conical shapes are also suitable in some embodiments.

The bearings 16 may be rollably attached to the first surface 18 of the platform 12 in any suitable manner. For example, one or more bearings 16 may be housed in a cage or separator 32 (FIG. 2). In these embodiments, the cage or separator 32 is typically connected to the first surface 18 of the platform 12 such that the bearing 16 may freely roll within the cage or separator 32. Typically, in these embodiments, the cage or separator 32 is attached to the platform 12 in a manner such that the two will not become detached during normal use. For example, gluing and tying the cage assembly or separator 32 to the platform 12 have both been found to be effective. The cage assembly can be readily secured to the writing platform by using a single strand from braided wire like that used in hanging picture frames. Alternatively, the cage assembly can be held in place by 3 parallel nylon strips 35 (FIG. 1A), such that the entire assembly can glide freely back and forth under the platform during use. This enhances the writing platform's movement in a straight line. An additional nylon strip 41 (FIG. 1A) keeps the cage assembly confined to the undersurface of the platform during use, thereby maintaining the writing aid together as a single functional unit.

The bearings 16 may be placed in any suitable location and in any suitable configuration on the first surface 18 of the platform 12. For example, as shown in FIG. 2, multiple linear bearings 17 may be attached parallel to one another on the platform 12. Likewise, spherical bearings 28 may be configured in a pattern, such as the circular pattern shown in FIG. 2. Configurations, such as those described above, reduce the friction between the writing aid 10 and the writing surface and provide a stable base on which the writing aid 10 stands. Preferably, at least some of the bearings 16 are located near the outer periphery of the platform 12 in order to provide the writing aid 10 with increased stability and to substantially prevent the writing aid 10 from tipping or wobbling during use.

In embodiments utilizing linear bearings 17, it is preferable that the linear bearings 17 are oriented on the first surface 18 of the platform 12 such that the linear bearings 17 reduce the friction between the writing aid 10 and the writing surface in a direction substantially parallel to the direction in which the writing aid 10 is typically moved when writing. For example, as shown in FIG. 2, the bearings 16 are aligned to rotate about an axis 30 that is substantially perpendicular to the direction of Arrows “A” and “B”, (i.e., the directions a typical user moves his or her hand when writing). Therefore, the linear bearings 17 of FIG. 2 are operable to encourage the user to write along a substantially straight line because the bearings 17 typically have the least amount of resistance in the directions of Arrows “A” and “B”.

Any combination of bearings 16 may be placed on the first surface 18 of the writing aid 10. For example, as shown in FIG. 2, linear bearings 17 may be used on one portion of the writing aid 10 and spherical bearings 28 used on another. As discussed above, the different styles of bearings 16 reduce friction between the writing aid 10 and the writing surface in different manners and, therefore, using various different styles of bearings 16 varies the frictional forces created between the writing aid 10 and the writing surface during use. For example, in some embodiments, it is preferable to have linear bearings 17 located in one portion of the platform 12 where linear motion is desirable and spherical bearings 28 in another portion of the platform 12 where it is desirable to have a greater degree of freedom of motion in all directions.

The bearings 16 may also be of any suitable size. In a preferred embodiment, the bearings 16 have a height (H) of approximately ⅛″ (or 4.0 mm). However, in other embodiments, the bearings 16 may be either taller or shorter, depending upon the personal preferences of the end user. For example, a user that prefers to hold a pen or pencil in a more upright position may prefer to use taller bearings 16 so that his or her hand is raised higher from the writing surface when writing.

Although any type of bearings 16 may be used, flat cage linear bearing assemblies made commercially available by Hydrel AG of Romanshorn, Switzerland and sold under the name “ZW Series” have been shown to have particular utility.

Referring to FIGS. 1 and 3, the top layer 14 is affixed to, and covers at least a portion of the second surface 20 of the platform 12. The top layer 14 is operable to provide cushioning between the user's hand and the platform 12 during use. The top layer 14 may be made of any suitable material. For example, commercially available foams, gels, and felts are suitable top layer materials. However, the above-listed materials are not to be considered exhaustive of the potential top layer materials. It is also preferable that material of the top layer 14 creates sufficient friction with the user's hand to prevent the user from undesirably “slipping” off, or moving relative to, the writing aid 10 during use.

The top layer 14 may be flat or contoured. For example, as shown in FIG. 1, the top layer 14 is generally flat. In these embodiments, the user may place his or her hand on the writing aid 10 in any orientation. In other embodiments, such as the one shown in FIG. 3, the top layer 14 may be contoured, or more preferably, ergonomically contoured. In these embodiments, the top layer 14 is operable to conform to the shape of the user's hand. An ergonomic top layer 14 aids in, inter alia, preventing the user's hand from “slipping off” the writing aid.

According to one aspect of the present invention, the writing aid 10 may include a support loop 34, as shown in FIG. 3. The support loop 34 is connected to the platform 12 and/or the top layer 14. The support loop 34 may be made of any suitable material. For example, string and elastic bands are suitable loop material choices. The support loop 34 is sized to be selectively wrapped around at least part of the user's hand, depending on the preference of the end user. For example, one user may desire to wrap the support loop 34 around his or her wrist, while another user may desire to wrap the support loop 34 around one or more of the his or her fingers. The support loop 34 enables the user to maintain enhanced control of the writing aid 10 during use. The support loop 34 can be attached to any location on the platform, which allows for the most comfort and ease of use.

According to another aspect of the present invention, the writing aid 10 includes a guard 36 that is attached to one or both of the platform 12 and top layer 14. As shown in FIG. 1, the guard 36 is curved, or angled, and extends substantially over at least one side 38 of the writing aid 10 to a position adjacent at least one of the bearings 16. The guard 38 is operable to enable the writing aid to transition from a first surface to a second surface smoothly by decreasing the likelihood that the side 38 of the writing aid 18 will “catch” or “snag” the edge of the writing surface during use. The guard 38 may be made of any suitable material; however, metals and polymeric materials have been shown to have particular utility.

In operation, the user places his or her writing hand on the top surface 14 of the writing aid 10, places the writing instrument in contact with the writing surface and begins to write or draw. As user writes, the writing instrument advances across the writing surface. Because the bearings 16 reduce the friction between the writing aid 10 and the writing surface, the user is able also to move the writing aid 10, which supports his or her writing hand, across the writing surface at a desired rate. Therefore, the user is able maintain a desirable distance between the position at which the user supports his or her writing hand and the point at which the writing instrument contacts the writing surface at all times. In some instances, the user may desire to use his or her non-writing hand to stabilize and guide the writing aid in order to gain even more control over the position at which the user supports his or her writing hand when writing.

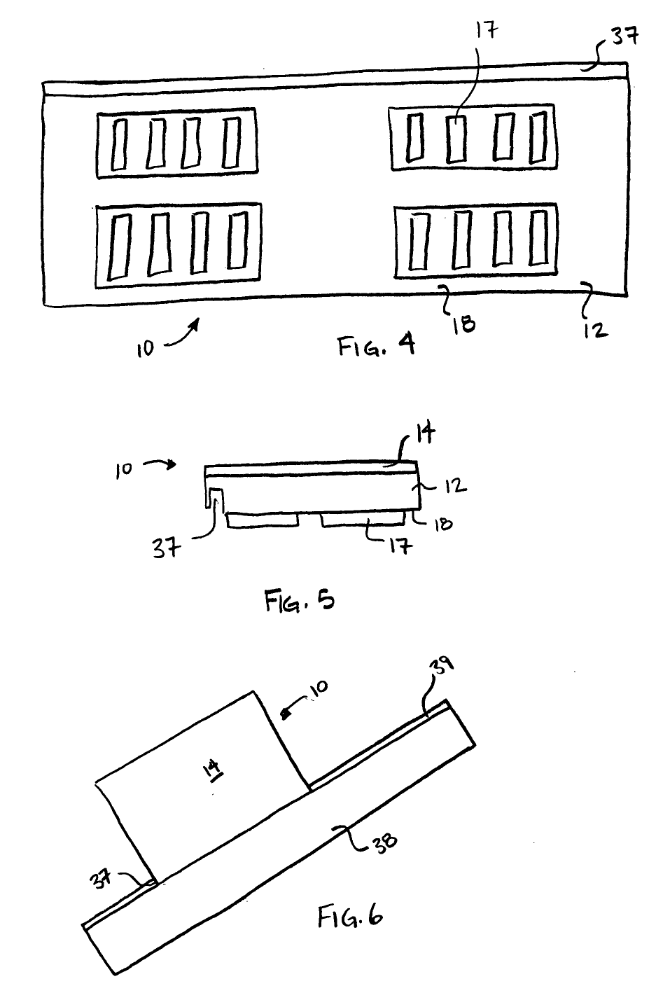

According to another aspect of the present invention and now referring to FIGS. 4, 5 and 6, the writing aid 10 may include a groove 37 in order for the writing aid to be used in conjunction with a guide ruler 38. In these embodiments, the guide ruler 38 includes a track 39 that is complimentary to the groove 37 located on the platform 12. During use, the platform 12 and accordingly, the writing aid 10, can be maneuvered along a substantially straight line. This variation offers the user an additional mode of fine-tuning the movements of the writing aid 10, thereby resulting in improved legibility and clarity.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

1. A writing aid, comprising:
a platform sized to accommodate a hand and/or wrist of a user, has a first surface and second surface;
a top layer affixed to at least a portion of the second surface of the platform, wherein the top layer is made of a material that provides cushioning between the user's hand and the platform;
two or more bearings systems rollably attached to the first surface of the platform, the two or more bearings being operable to reduce the friction between the platform and a writing surface; and
wherein at least one of the bearings is a linear bearing that rotates about an axis.

2. The writing aid of claim 1, wherein the platform is rigid and substantially flat.

3. The writing aid of claim 1, wherein the platform is approximately ⅛″ (4.0 mm) thick.

4. The writing aid of claim 1, wherein the platform is substantially rectangular.

5. The writing aid of claim 1, wherein the loop is operable, may be selectively wrapped around at least part of the user's hand (wrist, palm or fingers, singly or in any combination) for comfort and ease of use.

6. The writing aid of claim 1, wherein at least one of the sides of the platform is chamfered.

7. The writing aid of claim 1, wherein at least one of the sides of the platform is rounded.

8. The writing aid of claim 1, wherein at least one of the bearings is located near an outer periphery of first surface of the platform.

9. The writing aid of claim 1, wherein the the linear bearings are oriented on the first surface of the platform such that the linear bearings reduce friction in a direction substantially parallel to the direction to that which the user moves his or her hand when writing.

10. The writing aid of claim 1, wherein the bearings have a height of approximately ⅛″.

11. The writing aid of claim 1, wherein the top layer is substantially flat.

12. The writing aid of claim 1, wherein the top layer is contoured.

13. The writing aid of claim 12, wherein the top layer is ergonomically contoured.

14. The writing aid of claim 1 further including a loop attached to one or both of the top layer and the platform, wherein the loop is operable to be selectively wrapped around at least part of the user's hand.

15. The writing aid of claim 14, wherein the loop is made of string.

16. The writing aid of claim 14, wherein the loop is made of elastic material.

17. The writing aid of claim 1 further including a guard that is attached to one or both of the top layer and the platform and extends substantially over at least one side of the writing aid to a position adjacent at least one of the bearings.
